(19) United States
(12) Patent Application Publication
(10) Pub. No.: US 2015/0282441 A1
(43) Pub. Date: Oct. 8, 2015

(54) IRRIGATION APPARATUS AND FEEDING SYSTEM

(71) Applicant: Aaron MARSHALL, Studio City, CA (US)

(72) Inventor: Aaron MARSHALL, Studio City, CA (US)

(21) Appl. No.: 14/245,731

(22) Filed: Apr. 4, 2014

(51) Int. Cl. A01G 27/00

(52) U.S. Cl. CPC A01G 27/00

(57) ABSTRACT

An irrigation apparatus and feeding system for dispersing liquid through a plant growing medium are disclosed. The apparatus includes a geometrically shaped container of variable size configured to be detachable in at least two pieces at first and second sides. Container has an outer wall with an inner surface, an open top, and a base portion configured to cover the plant growing medium. Base portion is configured with a plurality of holes for receiving liquid therethrough. Container is configured with at least one center opening therethrough having an inner wall for receiving a plant when first and second sides of container are adjoined together. The plurality of holes are each configured with a dripper for receiving liquid extending therethrough the base portion such that the dripper feeds the plant growing medium at variable flow rates and intervals and provides stability for the apparatus to be secured in the plant growing medium.

### TECHNICAL FIELD

The present invention relates to the field of horticultural irrigation apparatus and watering systems, and more particularly, to an automated irrigation apparatus and system for feeding or watering plants and the like.

### BACKGROUND

Plants typically require feeding or watering or otherwise supplementing with liquid nutrition at least once weekly to survive. During occasions when an individual plans to be away from home for an extended period of time, the individual needs to make arrangements for the care of his or her plants. This involves the cost and inconvenience of hiring help to care for the plants and compromises the individual's privacy in the home or personal space.

Various self-watering plant watering or feeding apparatus and systems have been developed, but such apparatus and systems are not specifically designed for simple, convenient, and economical use due to their complex construction, and are not easily adaptable to an existing plant container or medium. It would thus be desirable to have an improved automated irrigation apparatus and system for feeding or watering plants and the like, which avoids the disadvantages of the known apparatus and systems.

### SUMMARY

In a first aspect, there is provided herein an irrigation apparatus for dispersing liquid through a plant growing medium. The apparatus includes a geometrically shaped container of variable size configured to be detachable in at least two pieces at a first side and a second side, the container having an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant when the first side and the second side of the container are adjoined together. The plurality of holes are each configured with a dripper for receiving liquid extending therethrough the base portion such that the dripper feeds the plant growing medium at variable flow rates and intervals and provides stability for the apparatus to be secured in the plant growing medium.

In certain embodiments, the geometrically shaped container is a circle, cube, cylinder, rectangle, or square.

In certain embodiments, the geometrically shaped container is transparent or clear having a measuring table disposed thereon the inner surface.

In certain embodiments, the base portion may be flat or curved.

In certain embodiments, the plurality of holes are variably sized such that the holes retain the liquid in the container for about 10 to about 60 minutes during feeding of the plant.

In certain embodiments, the inner wall center opening for receiving the plant may be circular, conical, or cylindrical.

In certain embodiments, the outer wall of the container may be configured with an adapter for use with a hose or pump system.

In certain embodiments, the first side and the second side of the container are configured to be adjoined together via at least a one male to one female ratio or other combinations of male to female ratios.

In certain embodiments, the apparatus further includes a plurality of variable size openings disposed on the inner wall for use as a flood drain for excess liquid retained in the container to be directed to a center of the plant growing medium.

In certain embodiments, the container includes at least one longitudinal section having a first end and a second end such that the second end is attached to the base portion.

In certain embodiments, the longitudinal section is configured with an opening therethrough for receiving a support structure from the first end to the second end such that at least a portion of the support structure is positioned in the plant growing medium for providing support to the plant.

In certain embodiments, the support structure is a bamboo, wood, or plastic stick.

In certain embodiments, the longitudinal section may be configured to be perpendicular or angled in relation to the base portion.

In certain embodiments, the container includes an overhang lip portion formed on a top edge of the outer wall for blocking light to the plant growing medium.

In certain embodiments, the overhang lip portion includes a downward lip extending therefrom a first end of the overhang lip portion for blocking light to the plant growing medium.

In certain embodiments, the dripper may be at least one of a soaker hose, a porous pipe, drip tape, laser tubing, short-path emitters, and tortuous-path or tubulent-flow emitters.

In certain embodiments, the container is configured with at least two stakes disposed at a first end and a second end of the container for securing the container in the plant growing medium.

In a second aspect, there is provided herein an irrigation apparatus for dispersing liquid through a plant growing medium. The irrigation apparatus includes a geometrically shaped container of variable size having an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant. The plurality of holes are each configured with a dripper for receiving liquid extending therethrough the base portion such that the dripper feeds the plant growing medium at variable flow rates and intervals and provides stability for the apparatus to be secured in the plant growing medium.

In certain embodiments, the at least one center opening is configured to have at least one longitudinal opening extending therefrom to the outer wall to allow placement of the container on the plant or to allow removal of the container from the plant.

In a third aspect, there is provided herein an irrigation feeding system for dispersing liquid through a plant growing medium. The system includes an irrigation apparatus having a geometrically shaped container of variable size. The container has an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant. The plurality of holes are each configured with a dripper for receiving liquid extending therethrough the base portion such that the dripper feeds the plant growing medium at variable flow rates and intervals and provides stability for the apparatus to be secured in the plant growing medium.

In certain embodiments, the container is configured to be detachable in at least two pieces at a first side and a second side.

In certain embodiments, the first side and the second side of the container are configured to be adjoined together via at least one male to one female ratio or other combinations of male to female ratios.

In certain embodiments, the irrigation feeding system further includes a digital moisture meter removably connected to the outer wall for monitoring moisture levels of the plant growing medium. At least one moisture sensor for monitoring moisture levels of the plant growing medium may be optionally used in combination with the digital moisture meter. The at least one moisture sensor is optimally positioned at a variable angle in the plant growing medium proximate to the digital moisture meter. A submersible pump is positioned inside a liquid holding reservoir for pumping liquid to the apparatus, such that the submersible pump is configured to be connected to the digital moisture meter by at least one wire for communication therewith. The irrigation feeding system further includes a hose having a first end and a second end such that the first end of the hose is configured to be connected to an adapter disposed on the submersible pump and the second end of the hose is configured to be connected to an adapter disposed on the outer wall of the container. Liquid is pumped from the liquid holding reservoir through the hose to the container such that liquid is dispersed through the plant growing medium at appropriate flow rates and intervals when the plant reaches a predetermined moisture and humidity level.

In certain embodiments, the digital moisture meter includes a digital moisture display such that when used with a plurality of manual functions, the display provides variable settings for a specific moisture level at which a user would like the system to feed the plant growing medium.

In certain embodiments, the plurality of manual functions enable the user to view feeding history, set times, feeding schedules, and manually operate the digital moisture meter.

In certain embodiments, the system may be used with a plurality of pumps on a submersible power strip having a single power supply.

In certain embodiments, the plurality of holes are variably sized such that the holes retain the liquid in the container for about 10 to about 60 minutes during feeding of the plant.

Various advantages of this disclosure will become apparent to those skilled in the art from the following detailed description, when read in light of the accompanying drawings.

### BRIEF DESCRIPTION OF THE DRAWINGS

FIG. 1 is a perspective view of an exemplary embodiment of the irrigation apparatus setting on top of a plant growing medium according to the present disclosure.

FIGS. 2A-F are up close views of various geometric shapes of the irrigation apparatus of FIG. 1 according to the present disclosure.

FIG. 2G is an exemplary embodiment of the irrigation apparatus of FIG. 1 according to the present disclosure.

FIGS. 3A-B are side elevational views of the irrigation apparatus of FIG. 1 shown detached and having various male to female ratio configurations for the adjoining of first and second sides of the container according to the present disclosure.

FIG. 4 is a side cross-sectional view of the base portion of the irrigation apparatus of FIG. 1 shown with a sloped or curved bottom.

FIG. 5 is a top cross-sectional view of the irrigation apparatus of FIG. 1 according to the present disclosure.

FIG. 6 is a side cross-sectional view of another exemplary embodiment of the irrigation apparatus of FIG. 1 according to the present disclosure.

FIG. 7 is a side cross-sectional view of another exemplary embodiment of the irrigation apparatus of FIG. 1 according to the present disclosure.

FIG. 8 is a side elevational view of an exemplary embodiment of an irrigation feeding system using the irrigation apparatus of FIG. 1 according to the present disclosure.

FIG. 9A is a front elevational view of a digital moisture meter used in accordance with the irrigation apparatus and irrigation feeding system of the present disclosure.

FIG. 9B is a side elevational view of the digital moisture meter of FIG. 9A connected to the outer wall of the container according to the present disclosure.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In consideration of the figures, it is to be understood for purposes of clarity certain details of construction and/or operation are not provided in view of such details being conventional and well within the skill of the art upon disclosure of the document described herein.

The following terms and phrases shall have, for purposes of this application, the respective meanings set forth below:

The terms “feeding” and “watering” are used interchangeably herein and are intended to have the same meaning with respect to the treating of a plant with liquid nutrition so that the plant may grow and flourish.

The terms “dripper” and “emitter” are used interchangeably herein and are intended to have the same meaning with respect to drip irrigation in assuring that a uniform rate of flow of liquid is achieved.

The term “irrigation” refers to the application of water to soil or another medium by artificial means to foster plant growth.

The terms “growing medium,” “medium,” or “media” refer to a liquid or solid in which organic structures such as plants are placed to grow.

The term “liquid” refers to any form of liquid nutrition for a plant, including water and the like.

The term “Rockwool” refers to the inorganic mineral based horticultural grade Rockwool primarily sold as a hydroponic substrate in the horticultural industry.

The phrase “substrate growing system” is a hydroponic system in which the root zone is physically supported by media and the plants are fed by applying nutrient solution to the media.

The irrigation apparatus and irrigation feeding system of the present disclosure pertains to a self-watering irrigation apparatus and feeding system that allows a user to measure the amount of water as it is distributed onto a plant instead of pre-measuring or doing a count; provides for a slow thorough and even distribution of water or other liquid nutrition; prevents algae, mold, and weeds from growing in the plant growing medium by covering the medium in its entirety; low cost to manufacture; fabricated from inexpensive materials; durable; and easy to assemble and disassemble, among other desirable features as described herein.

It is contemplated by the present disclosure that the irrigation apparatus and irrigation feeding system may be used with any suitable plant growing medium (e.g., Rockwool, soil, and the like) in a substrate growing system.

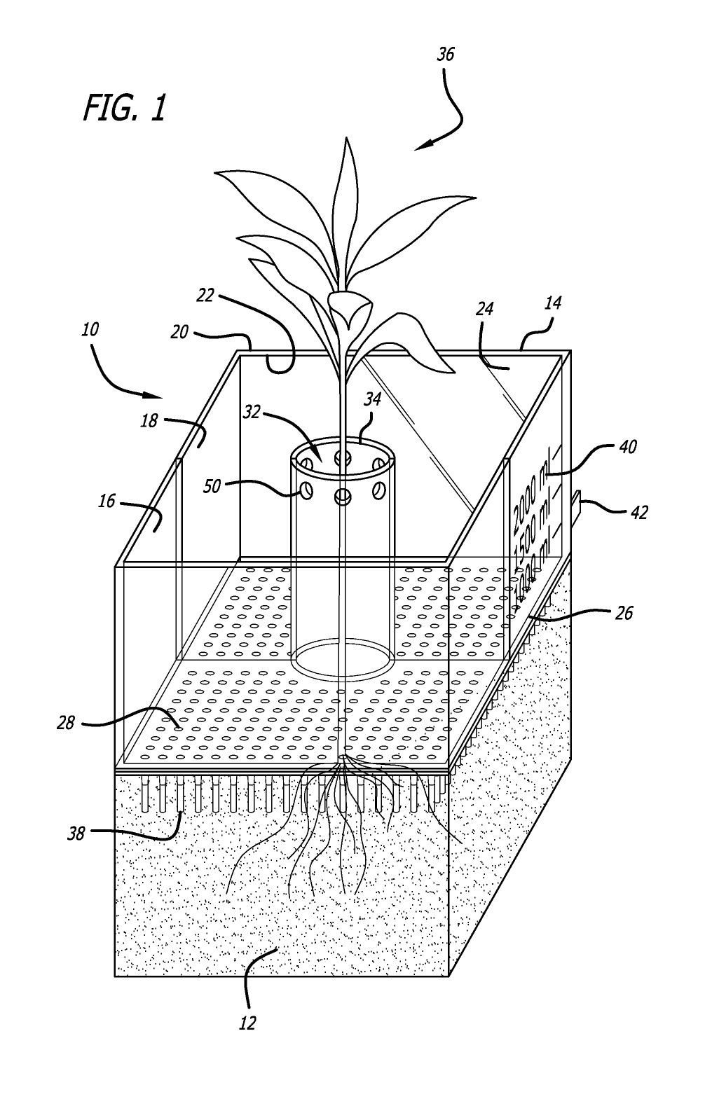

Referring now to FIG. 1 is a perspective view of an exemplary embodiment of the irrigation apparatus 10 setting on top of a plant growing medium 12 (e.g., Rockwool) according to the present disclosure. The irrigation apparatus 10 includes a geometrically shaped container 14 of variable size configured to be detachable in at least two pieces at a first side 16 and a second side 18. The container 14 has an outer wall 20 with an inner surface 22, an open top 24, and a base portion 26 configured to cover the plant growing medium 12. The base portion 26 is configured with a plurality of holes 28 for receiving liquid 30 therethrough.

As illustrated in FIG. 1, the container 14 is configured with at least one center opening 32 therethrough and includes an inner wall 34 for receiving a plant 36 when the first side 16 and the second side 18 of the container are adjoined together as a single container. The plurality of holes 28 are each configured with a dripper 38 for receiving liquid 30 extending therethrough the base portion 26 such that the dripper feeds the plant growing medium 12 at variable flow rates and intervals and provides stability for the apparatus 10 to be secured in the plant growing medium. It should be understood that the dripper may be configured to feed the plant growing medium at any suitable flow rate and interval in accordance with the present disclosure.

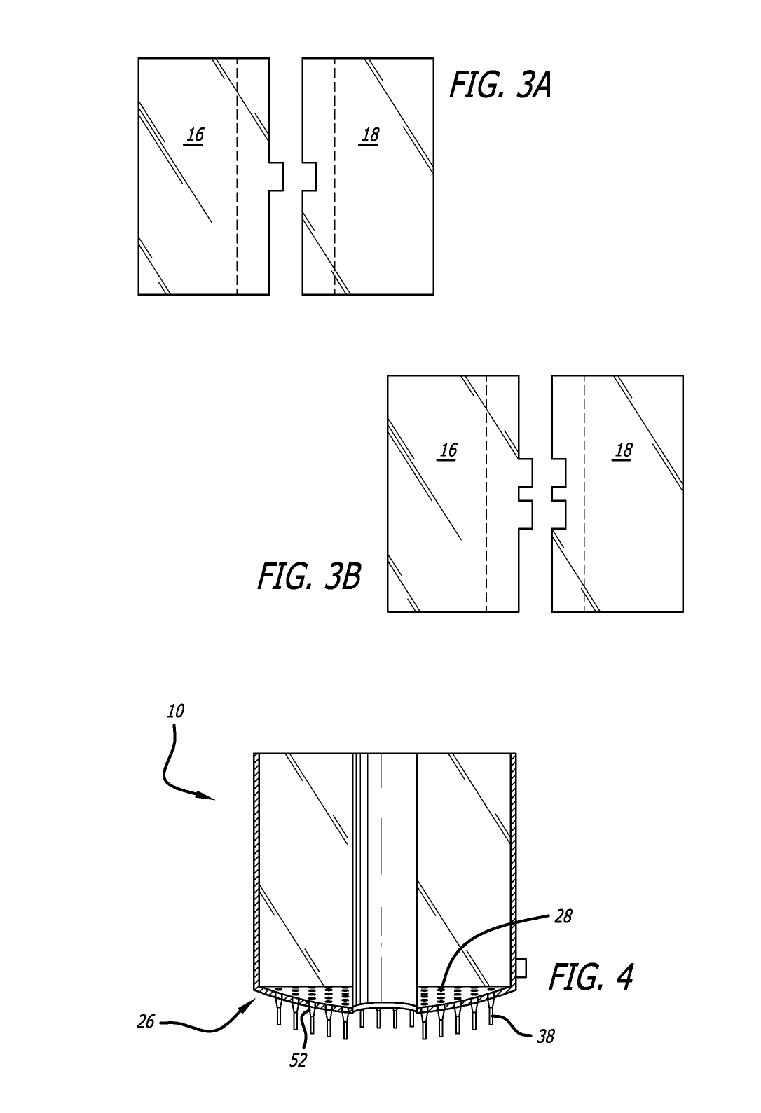

In accordance with the present disclosure, the geometrically shaped container 14 can be fabricated either as a single piece or as at least two separate pieces that are configured to be adjoined together at the first side 16 and the second side 18. The at least two piece configuration allows for easy installation or tear down of the container 14 by the user. In some embodiments, the first side 16 and the second side 18 are configured to be adjoined or secured together via at least a one male to one female ratio (FIG. 3A) or other suitable combinations of male to female ratios, including, but not limited to, male to two female, two male to three female, or two male to two female (FIG. 3B), and the like. It should be understood that the first side 16 and the second side 18 may be adjoined or secured together via any suitable notch configured within the female and end of the male.

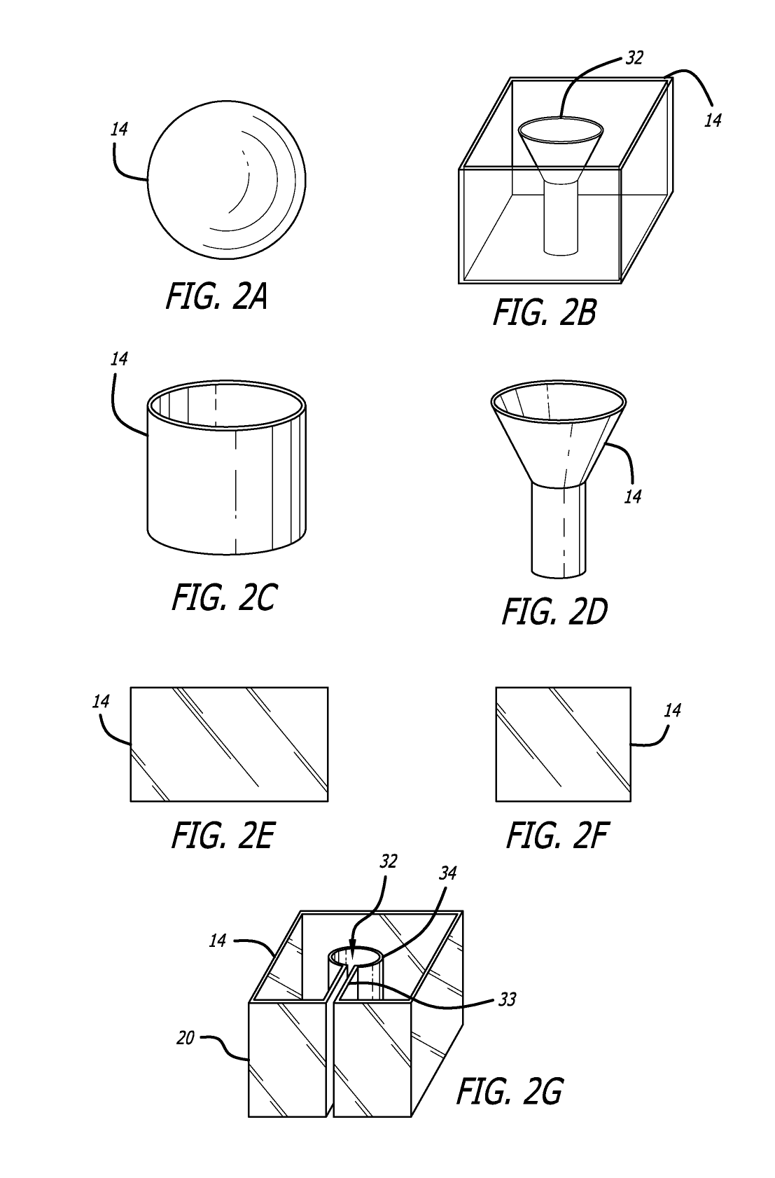

In one embodiment, the geometrically shaped container 14 can be a circle (FIG. 2A), cube (FIG. 2B), cylinder (FIG. 2C), conical (FIG. 2D), rectangle (FIG. 2E), square (FIG. 2F), or any other suitable geometrical shape. It should be understood that the container can be manufactured to suit any plant size growing medium and is sized to scale. For example, the container may be a cube with dimensions of 8 inches (height)×8 inches (width)×8 inches (length) and outer walls of 3/16 of an inch thick such that the container fits a Rockwool cube of same approximate dimensions.

The container may be fabricated of any sturdy material capable of retaining liquids or fluids (e.g., water), including metal, plastic, and the like.

In one embodiment, the geometrically shaped container 14 is transparent or clear having a measuring table 40 disposed thereon the inner surface 22, as illustrated in FIG. 1. It should be understood that the amount of volume each unit or container 14 can hold will be according to scale such that a plant growing in a 4 inches×4 inches×4 inches Rockwool cube does not require the same amount of liquid nutrition as a plant in a five gallon pot. For example, the measuring table 40 for a plant growing in an 8 inches×8 inches×8 inches Rockwool cube will allow up to approximately 2000 ml of liquid nutrition. Alternatively, the measuring table 40 for a plant growing in a 6 inches×6 inches×6 inches Rockwool cube will allow up to approximately 1200 ml of liquid nutrition.

In accordance with the present disclosure, the outer wall 20 of the container 14 may be configured with an adapter 42 for use with a hose 44 or pump 46 system, such that the irrigation apparatus 10 may be used in conjunction with the irrigation feeding system 48 disclosed herein. In some embodiments, the adapter 42 may be 0.5 inches in size with a cap for use with or without the irrigation feeding system or a hose or pump system that the user may wish to apply. It should be understood that the adapter can be of any type and size suitable for connecting the hose to the container.

In some embodiments, the container 14 is configured to include a plurality of variable size openings 50 disposed on the inner wall 34 for use as a flood drain for excess liquid retained in the container during feeding of the plant 36 to be directed to the center of the plant growing medium 12. It should be understood that the openings 50 disposed on the outer wall can be of any suitable size or dimension, preferably within the range of from about ⅛ of an inch to about one inch. In one embodiment, the openings are configured to be about ⅛ of an inch, such that excess liquid can flow therethrough and be directed to the areas where the plant requires additional moisture.

The at least one center opening 32 of the inner wall 34 for receiving the plant 36 may be circular (FIG. 1), conical (FIG. 2B), or cylindrical (FIG. 2C) to accommodate various sizes of plants. It should be understood that the container 14 may be configured with multiple center openings to allow multiple plants to be received. In one embodiment, the at least one center opening 32 is fabricated to have about a two inch diameter, which enables the base of the plant 36 space to grow in the plant growing medium 12. It should be understood that the at least one center opening can be configured of any suitable size and is sized to scale relative to the size of the container.

Referring to FIG. 2G is a side cross-sectional view of an exemplary embodiment of the irrigation apparatus of FIG. 1 according to the present disclosure. Specifically, the at least one center opening 32 can be configured to have at least one longitudinal opening 33 extending therefrom to the outer wall 20 to allow placement of the container 14 on or removal of the container from the plant 36. In this embodiment, the container is configured to bend to fit around the base of variable size plants. The at least one longitudinal opening 33 is configured to have the same height wall as the outer wall 20 of the container 14 while receding to a variable degree to the inner wall 34 of the at least one center opening 32.

FIG. 4 is a side cross-sectional view of the base portion 26 of the irrigation apparatus 10 of FIG. 1 shown with a sloped or curved bottom. In some embodiments, the base portion 26 may be flat (FIG. 1) or curved (FIG. 4). The base portion 26 may be configured to decline outward to inward from about ⅜ of an inch to about 3/16 of an inch in the curved embodiment such that the liquid 30 flows downward through the plurality of holes 28 into the dripper 38 for feeding the plant growing medium 12. The plurality of holes 28 of the base portion 26 may be configured to be about ¼ of an inch and gradually recede to about a 1/16 of an inch to about 1/64 of an inch chamber 52 of the dripper 38. It should be understood that the plurality of holes and the dripper can be sized to scale as appropriate. The number of drippers 38 used in conjunction with the irrigation apparatus 10 can range from about one or greater, according to the present disclosure.

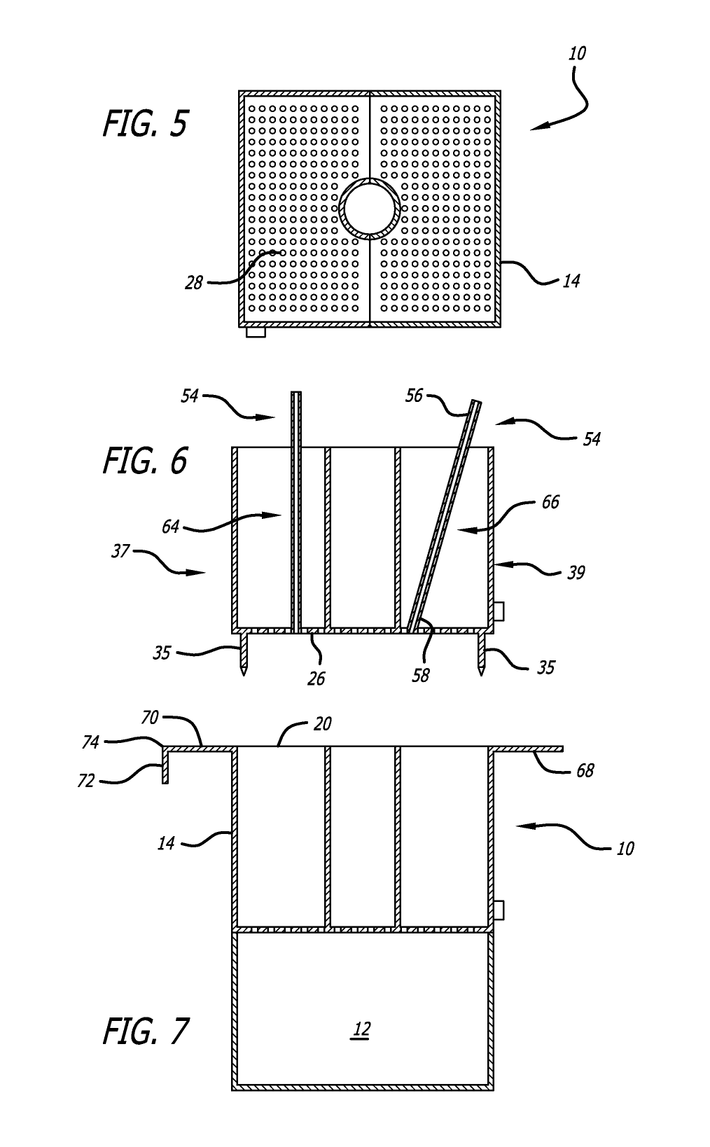

FIG. 5 is a top cross-sectional view of the irrigation apparatus 10 of FIG. 1 according to the present disclosure. In some embodiments, the plurality of holes 28 of the base portion 26 are variably sized such that the holes retain the liquid in the container 14 for about 10 to about 60 minutes during feeding of the plant 36. It should be understood that the plurality of holes of the base portion can be configured to retain the liquid in the container for other suitable time intervals or periods other than disclosed herein during feeding of the plant.

FIG. 6 is a side cross-sectional view of another exemplary embodiment of the irrigation apparatus according to the present disclosure. Specifically, the container 14 can be configured with at least two stakes 35 disposed at a first end 37 and a second end 39 of the container for securing the container in the plant growing medium 12. In accordance with the present disclosure, the at least two stakes 35 can be used when the dripper 38 is laser tubing.

Referring further to FIG. 6, the container 14 may include at least one longitudinal section 54 having a first end 56 and a second end 58 such that the second end is attached to the base portion 26. The longitudinal section 54 is configured with an opening 60 therethrough for receiving a support structure 62, such as a bamboo, wood, or plastic stick, from the first end 56 to the second end 58 such that at least a portion of the support structure is positioned in the plant growing medium 12 for providing additional support to the plant and plant growing medium 12. In one embodiment, the at least one longitudinal section 54 is about ¼ inch thick and the opening 60 is about ¼ inch to about ½ inch wide according to scale. The at least one longitudinal section 54 may be configured to be positioned perpendicular 64 or angled 66 in relation to the base portion 26. It should be understood that the at least one longitudinal section can be configured of any suitable size and is sized to scale.

FIG. 7 is a side cross-sectional view of another exemplary embodiment of the irrigation apparatus 10 according to the present disclosure. In particular, the container 14 includes an overhang lip portion 68 formed on a top edge 70 of the outer wall 20 for blocking light to the plant growing medium 12. By covering the plant growing medium 12 from light, the irrigation apparatus 10 prevents algae, mold, and weeds from growing in the plant growing medium. In another embodiment, the overhang lip portion 68 includes a downward lip 72 extending therefrom a first end 74 of the overhang lip portion for blocking light to the plant growing medium 12. It should be understood that the overhang lip portion and downward lip can be of any suitable size such that light is blocked to the plant growing medium and is sized to scale.

The overhang lip portion 68 and downward lip 72 may be fabricated of any opaque material suitable for blocking light, including metal, plastic, stone, wood, and the like.

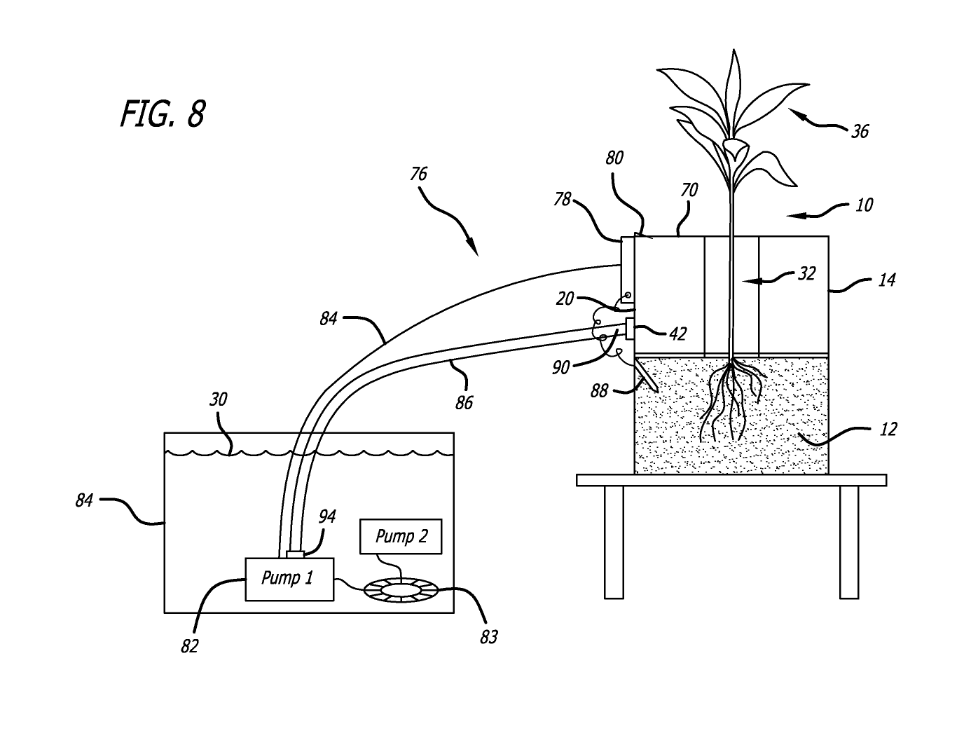

FIG. 8 is a side elevational view of an exemplary embodiment of the irrigation feeding system using the irrigation apparatus of FIG. 1 according to the present disclosure. The irrigation feeding system 76 for dispersing liquid 30 through a plant growing medium 12 includes the irrigation apparatus 10 as previously disclosed above. In some embodiments, the container 14 is configured to be detachable in at least two pieces at first side 16 and second side 18. The first side 16 and second side 18 are configured to be adjoined or secured together via at least one male to one female ratio or other combinations of male to female ratios as previously disclosed above.

The irrigation feeding system 76 further includes a digital moisture meter 78 removably connected to the outer wall 20 for monitoring moisture levels of the plant growing medium 12. The digital moisture meter 78 can be connected to the outer wall 20 of the container 14 via a hinged clip or clamp 80 integral to the digital moisture meter or separate therefrom or via a material that slides on to the top edge 70 of the outer wall 20.

At least one moisture sensor 88 for monitoring moisture levels of the plant growing medium 12 may be optionally used in combination with the digital moisture meter 78 such that the at least one moisture sensor is optimally positioned at a variable angle in the plant growing medium proximate to the digital moisture meter as shown in FIG. 8. In some embodiments, the at least one moisture sensor 88 may be positioned at about a 45 degree angle from the digital moisture meter 78 such that the sensor penetrates to the approximate center of the plant growing medium 12 for an accurate reading.

A submersible pump 82 positioned inside a liquid holding reservoir 84 pumps liquid to the irrigation apparatus 10. The submersible pump can be any suitable aquarium pump as used in fish tank aquariums. The liquid holding reservoir may be fabricated of any sturdy material capable of retaining liquids or fluids (e.g., water), including metal, plastic, and the like. The submersible pump 82 is configured to be connected to the digital moisture meter 78 by at least one wire 84 for communication therewith the digital moisture meter. The wire can be connected from the pump to the digital moisture meter via a waterproof connection of the type manufactured by King Innovation (O'Fallon, Mo.) called DRYCONN®.

In some embodiments, the irrigation feeding system 76 may be used with a plurality of submersible pumps 82 on a submersible power strip 83 having a single power supply.

The irrigation feeding system 76 further includes a hose 86 having a first end 90 and a second end 92 such that the first end of the hose is configured to be connected to an adapter 94 disposed on the submersible pump 82 and the second end of the hose is configured to be connected to adapter 42 disposed on the outer wall 20 of the container 14. Liquid 30 is pumped from the liquid holding reservoir 84 through the hose 86 to the container 14 such that liquid is dispersed through the plant growing medium 12 at appropriate flow rates and intervals when the plant 36 reaches a predetermined moisture and humidity level. It should be understood that the irrigation feeding system disperses liquid into the plant growing medium at any appropriate flow rate and interval when a predetermined moisture and humidity level is reached by the plant. For example, a volume of 2000 ml of liquid is dispersed into the plant growing medium within a period of about 10 minutes.

The irrigation apparatus and irrigation feeding system of the present disclosure can be used with any suitable drippers or emitters, such as those with an extremely small hole in the tube (e.g., soaker hose, porous pipe, drip tape, laser tubing), those that work well on very low-pressure systems (e.g., short-path emitters), and those that are less likely to clog up (e.g., tortuous-path or turbulent-flow emitters).

Drippers or emitters are manufactured in a variety of different flow rates. The most common flow rates, suitable for use with the irrigation apparatus and irrigation feeding system of the present disclosure, include as follows:

2.0 liters/hour-½ gallon/hour

4.0 liters/hour-1 gallon/hour

8.0 liters/hour-2 gallons/hour

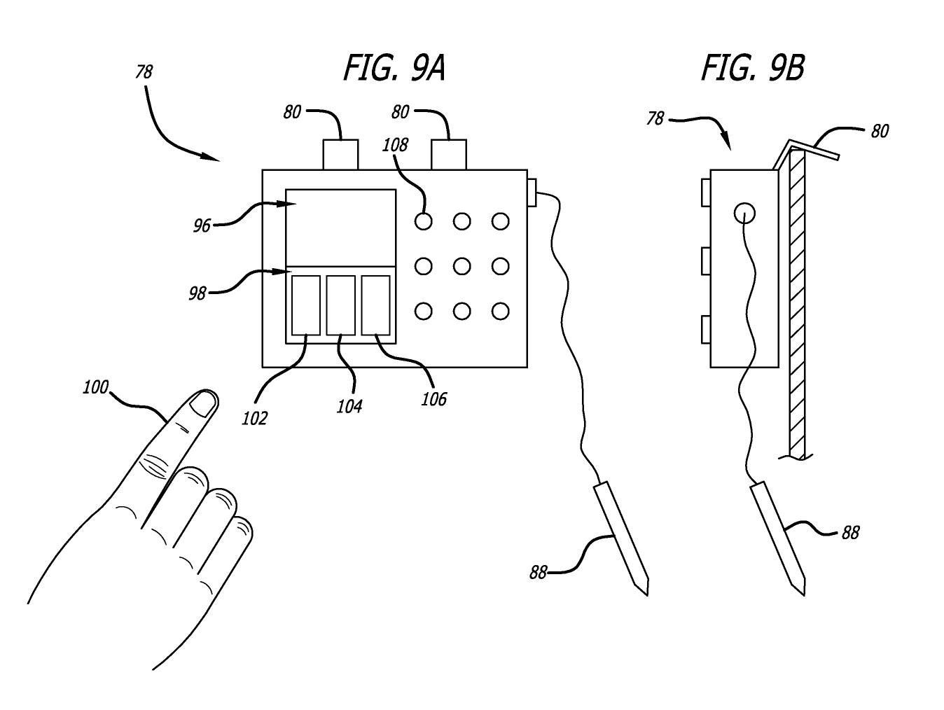

FIG. 9A is a front elevational view of a digital moisture meter 78 used in accordance with the irrigation apparatus 10 and irrigation feeding system 76 of the present disclosure. The digital moisture meter 78 includes a digital moisture display 96 such that when used with a plurality of manual functions, the display provides variable settings 98 for a specific moisture level at which a user 100 would like the irrigation feeding system to feed the plant growing medium. In some embodiments, the plurality of manual functions enable a user 100 to view feeding history 102, set times 104, feeding schedules 106, and manually operate the digital moisture meter via an on/off button or switch 108. Specifically, feeding history may include the number of times the plant has fed since the last time a user has checked as well as the dates and times the plant has fed. Setting times include use of a clock for setting how many seconds and/or minutes the user would like the pump to be on in filling up the irrigation apparatus. Feeding schedules include use of a calendar for adjusting the moisture level of the plant to be a certain level for specific days, weeks, or months. The manual on/off button or switch enables the user to calculate how many seconds or minutes it takes to fill up the irrigation apparatus.

FIG. 9B is a side elevational view of the digital moisture meter 78 connected to the outer wall 20 of the container 14 by hinged clip or clamp 80 according to the present disclosure.

Several of the features and functions disclosed above may be combined into different systems or applications, or combinations of systems and applications. Various presently unforeseen or unanticipated alternatives, modifications, variations or improvements therein may be subsequently made by those skilled in the art, each of which is also intended to be encompassed by the following claims.

What is claimed is:

1. An irrigation apparatus for dispersing liquid through a plant growing medium, the apparatus comprising:
a geometrically shaped container of variable size configured to be detachable in at least two pieces at a first side and a second side, the container having an outer wall with an inner surface, an open top, and a base portion configured to cover the plant growing medium, wherein the base portion is configured with a plurality of holes for receiving liquid therethrough;
the container being configured with at least one center opening therethrough having an inner wall for receiving a plant when the first side and the second side of the container are adjoined together;
wherein the plurality of holes are each configured with a dripper for receiving liquid extending therethrough the base portion such that the dripper feeds the plant growing medium at variable flow rates and intervals and provides stability for the apparatus to be secured in the plant growing medium.

2. The apparatus of claim 1, wherein the geometrically shaped container is a circle, cube, cylinder, rectangle, or square.

3. The apparatus of claim 1, wherein the geometrically shaped container is transparent or clear having a measuring table disposed thereon the inner surface.

4. The apparatus of claim 1, wherein the base portion may be flat or curved.

5. The apparatus of claim 1, wherein the plurality of holes are variably sized such that the holes retain the liquid in the container for about 10 to about 60 minutes during feeding of the plant.

6. The apparatus of claim 1, wherein the inner wall center opening for receiving the plant may be circular, conical, or cylindrical.

7. The apparatus of claim 1, wherein the outer wall of the container may be configured with an adapter for use with a hose or pump system.

8. The apparatus of claim 1, wherein the first side and the second side of the container are configured to be adjoined together via at least a one male to one female ratio or other combinations of male to female ratios.

9. The apparatus of claim 1 further comprising a plurality of variable size openings disposed on the inner wall for use as a flood drain for excess liquid retained in the container to be directed to a center of the plant growing medium.

10. The apparatus of claim 1, wherein the container includes at least one longitudinal section having a first end and a second end such that the second end is attached to the base portion.

11. The apparatus of claim 10, wherein the longitudinal section is configured with an opening therethrough for receiving a support structure from the first end to the second end such that at least a portion of the support structure is positioned in the plant growing medium for providing support to the plant.

12. The apparatus of claim 11, wherein the support structure is a bamboo, wood, or plastic stick.

13. The apparatus of claim 10, wherein the longitudinal section may be configured to be perpendicular or angled in relation to the base portion.

14. The apparatus of claim 1, wherein the container includes an overhang lip portion formed on a top edge of the outer wall for blocking light to the plant growing medium.

15. The apparatus of claim 14, wherein the overhang lip portion includes a downward lip extending therefrom a first end of the overhang lip portion for blocking light to the plant growing medium.

16. The apparatus of claim 1, wherein the dripper may be at least one of a soaker hose, a porous pipe, drip tape, laser tubing, short-path emitters, and tortuous-path or tubulent-flow emitters.

17. The apparatus of claim 1, wherein the container is configured with at least two stakes disposed at a first end and a second end of the container for securing the container in the plant growing medium.

18. An irrigation apparatus for dispersing liquid through a plant growing medium, the irrigation apparatus comprising:
a geometrically shaped container of variable size having an outer wall with an inner surface, an open top, and a base portion configured to cover the plant growing medium, wherein the base portion is configured with a plurality of holes for receiving liquid therethrough;
the container being configured with at least one center opening therethrough having an inner wall for receiving a plant;
wherein the plurality of holes are each configured with a dripper for receiving liquid extending therethrough the base portion such that the dripper feeds the plant growing medium at variable flow rates and intervals and provides stability for the apparatus to be secured in the plant growing medium.

19. The apparatus of claim 18, wherein the at least one center opening is configured to have at least one longitudinal opening extending therefrom to the outer wall to allow placement of the container on the plant or to allow removal of the container from the plant.

20. An irrigation feeding system for dispersing liquid through a plant growing medium, the system comprising:
an irrigation apparatus having a geometrically shaped container of variable size, the container having an outer wall with an inner surface, an open top, and a base portion configured to cover the plant growing medium, wherein the base portion is configured with a plurality of holes for receiving liquid therethrough;
the container being configured with at least one center opening therethrough having an inner wall for receiving a plant;
wherein the plurality of holes are each configured with a dripper for receiving liquid extending therethrough the base portion such that the dripper feeds the plant growing medium at variable flow rates and intervals and provides stability for the apparatus to be secured in the plant growing medium.

21. The irrigation feeding system of claim 20, wherein the container is configured to be detachable in at least two pieces at a first side and a second side.

22. The irrigation feeding system of claim 21, wherein the first side and the second side of the container are configured to be adjoined together via at least one male to one female ratio or other combinations of male to female ratios.

23. The irrigation feeding system of claim 20 further comprising:
a digital moisture meter removably connected to the outer wall for monitoring moisture levels of the plant growing medium;
at least one moisture sensor for monitoring moisture levels of the plant growing medium optionally used in combination with the digital moisture meter, wherein the at least one moisture sensor is optimally positioned at a variable angle in the plant growing medium proximate to the digital moisture meter;
a submersible pump positioned inside a liquid holding reservoir for pumping liquid to the apparatus, wherein the submersible pump is configured to be connected to the digital moisture meter by at least one wire for communication therewith;
a hose having a first end and a second end such that the first end of the hose is configured to be connected to an adapter disposed on the submersible pump and the second end of the hose is configured to be connected to an adapter disposed on the outer wall of the container;
wherein liquid is pumped from the liquid holding reservoir through the hose to the container such that liquid is dispersed through the plant growing medium at appropriate flow rates and intervals when the plant reaches a predetermined moisture and humidity level.

24. The irrigation feeding system of claim 23, wherein the digital moisture meter includes a digital moisture display such that when used with a plurality of manual functions, the display provides variable settings for a specific moisture level at which a user would like the system to feed the plant growing medium.

25. The irrigation feeding system of claim 24, wherein the plurality of manual functions enable the user to view feeding history, set times, feeding schedules, and manually operate the digital moisture meter.

26. The irrigation feeding system of claim 23, wherein the system may be used with a plurality of pumps on a submersible power strip having a single power supply.

27. The irrigation feeding system of claim 20, wherein the plurality of holes are variably sized such that the holes retain the liquid in the container for about 10 to about 60 minutes during feeding of the plant.
